(19) United States
(12) Patent Application Publication
(10) Pub. No.: US 2016/0047481 A1
(43) Pub. Date: Feb. 18, 2016

(54) AIR SUPPLY SYSTEM VALVE

(71) Applicant: Hyundai Motor Company, Seoul (KR)

(72) Inventor: Jeonghee Park, Suwon (KR)

(21) Appl. No.: 14/569,652

(22) Filed: Dec. 13, 2014

(30) Foreign Application Priority Data
Aug. 14, 2014 (KR) 10-2014-0105999

(51) Int. Cl. F16K 27/02; F16K 31/53; H01M 8/04; F16K 1/18

(52) U.S. Cl. CPC F16K 27/0227; F16K 1/18; F16K 31/53; H01M 8/04201; H01M 2250/20

(57) ABSTRACT

A valve that protects a gear box from a working fluid leaked from the valve is provided. The valve includes a cylinder in which a working fluid flows, a disk rotatably disposed within the cylinder and configured to control a flow path, and a shaft configured to transmit power to the disk. In addition, a gear box is connected to the shaft and a connector is configured to connect the gear box and the cylinder. Further, the connector includes a drain aperture configured to discharge the working fluid leaked from the cylinder.

### CROSS-REFERENCE TO RELATED APPLICATION(S)

This application is based on and claims the benefit of Korean Patent Application No. 10-2014-0105999, filed on Aug. 14, 2014 in the Korean Intellectual Property Office, the disclosure of which is incorporated herein in its entirety by reference.

### TECHNICAL FIELD

The present disclosure relates to a valve, and more particularly, to a valve structure that prevents damage to a gear box by leakage of a working fluid.

### BACKGROUND

FIG. 1 is an exemplary view describing the electricity generation principle of a general fuel cell according to the related art. Referring to FIG. 1, generally, the fuel cell is a power generation device that directly converts chemical energy of hydrogen and oxygen contained in hydrocarbon based fuel, such as methanol, ethanol, and natural gas, into electric energy using an electrochemical reaction. In particular, FIG. 1 is an exemplary view schematically describing the electricity generation principle of the fuel cell as described above according to the related art. Referring to FIG. 1, when air containing oxygen is supplied to a cathode 1 and fuel containing hydrogen is supplied to an anode 3, while electrolysis of water and a reverse reaction thereof are performed through an electrolyte membrane 2, electricity is generated. However, since a voltage of electricity generated in a single unit cell 4 is not substantial enough to be useful, the fuel cell is configured in a stack form in which a plurality of cells 4 are connected in series with each other.

A fuel cell vehicle is a vehicle that uses the fuel cell as a main power source. Within the fuel cell vehicle, power is generated using an electrochemical reaction of hydrogen and air (e.g., oxygen) in the stack of the fuel cell, and a significant amount of heat is incidentally generated by the electrochemical reaction together with power, and the fuel cell vehicle is configured to cool the heat generated in the stack of the fuel cell using coolant that passes through a radiator.

In addition, an air supply device configured to supply air to the stack is includes a compressor configured to compress external air into charged air, an intercooler configured to cool the charged air heated by the compressor to increase a density of the charged air, and the like. In addition, the air supply device enables cooling of the charged air near the intercooler using heat exchange between residual coolant passing through the radiator and the charged air. As described above, the fuel cell includes an air supply device, wherein the air supply device includes a valve that controls a supply of air to the air supply device.

FIG. 2 is an exemplary view illustrating leakage of a working fluid in a valve structure according to the related aft Referring to FIG. 2, the working fluid 6 leaked by pressure may flow into a gear box space 7. To prevent working fluid 6 from moving into the gear box space 7, a seal 3 (e.g., lip seal, seal embedded bearing, or the like) is applied to many of the valves. However, when a shaft 1 operates, and the seal may fail under certain conditions, such that the sealing may not be suitably performed, the working fluid may leak into a gear box.

The leaked working fluid may freeze a gear 4 during winter due to decreased temperatures, and when a controller is disposed within the gear box space 7 (e.g., a controller printed circuit board (PCB) is mounted in this space), an electric short-circuit occurs, which may cause a fire or other substantial malfunctions. However, when the working fluid that flows through the valve leaks into the gear box that operates the valve, the working fluid may have a negative influence on the controller disposed within the gear box space.

### SUMMARY

The present disclosure provides a valve that may protect a gear box from a working fluid leaked there into from the valve. In addition, the present disclosure provides a valve c that may improve safety of an air supply system for a fuel cell system.

The technical objects of the present disclosure are not limited to the above-mentioned technical objects, and other technical objects that are not mentioned will be clearly understood by those skilled in the art through the following descriptions.

According to an exemplary embodiment of the present disclosure, a valve may include: a cylinder in which a working fluid flows; a disk rotatably disposed within the cylinder and configured to control a flow path; a shaft configured to transmit power to the disk; a gear box connected to the shaft; and a connector configured to connect the gear box and the cylinder and may include a drain aperture through which the working fluid leaked from the cylinder may be discharged.

According to another exemplary embodiment of the present disclosure, a valve may include: a cylinder in which a working fluid flows; a disk rotatably disposed within the cylinder and configured to control a flow path; a shaft configured to transmit power to the disk; a gear box connected to the shaft and configured to adjust a rotational angle of the shaft; a first sealing member that encloses the shaft and disposed between the disk and the gear box; a second sealing member disposed between the first sealing member and the gear box; and a connector configured to accommodate the first and second sealing members and the cylinder and may include a drain aperture that reaches exterior air between the first and second sealing members. Details of exemplary embodiments will be described below with reference to the accompanying drawings.

### BRIEF DESCRIPTION OF THE DRAWINGS

The above and other objects, features and advantages of the present disclosure will be more apparent from the following detailed description taken in conjunction with the accompanying drawings, wherein;

FIG. 1 is an exemplary view for describing the electricity generation principle of a general fuel cell according to the related art;

FIG. 2 is an exemplary view illustrating leakage of a working fluid in a valve structure according to the related art;

FIG. 3 is an exemplary perspective view of a valve according to an exemplary embodiment of the present disclosure; and

FIG. 4 is an exemplary view illustrating arrangement of a sealing member disposed within the valve according to the exemplary embodiment of the present disclosure.

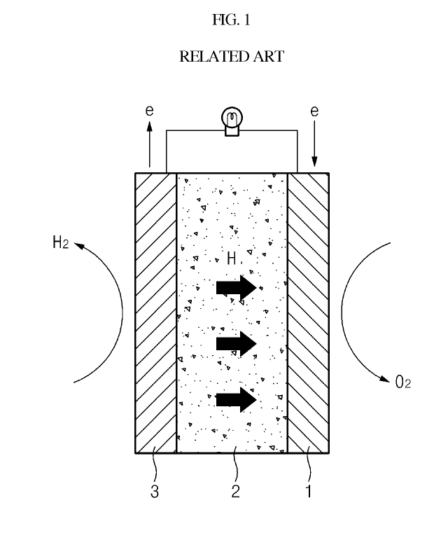

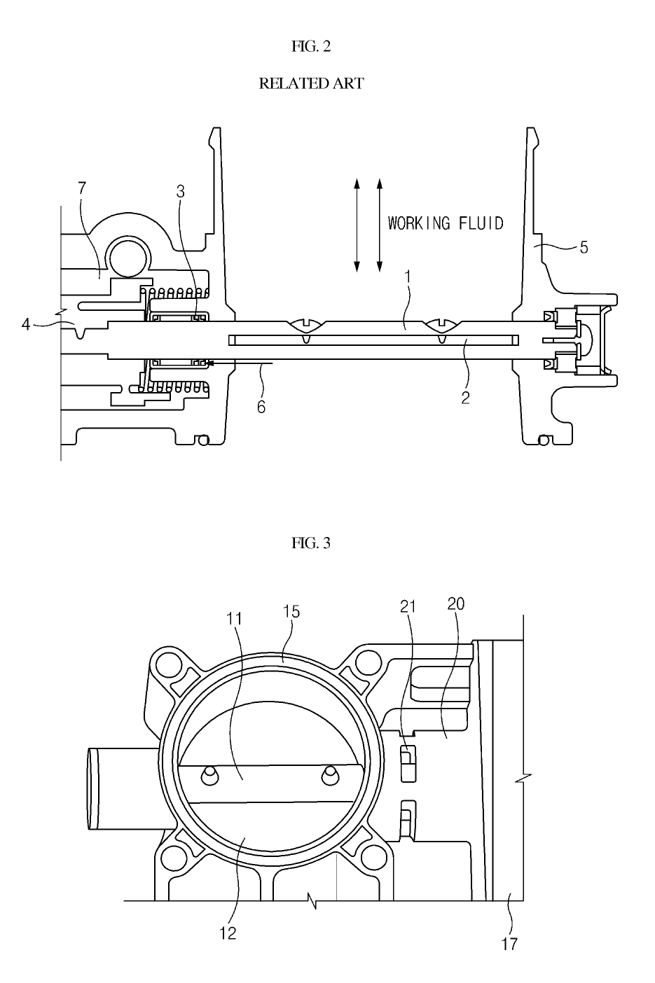

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Advantages and features of the present disclosure and methods to achieve them will be elucidated from exemplary embodiments described below in detail with reference to the accompanying drawings. However, the present disclosure is not limited to the exemplary embodiment disclosed herein but will be implemented in various forms. The exemplary embodiments make the present disclosure thorough and are provided so that those skilled in the art can easily understand the scope of the present disclosure. Therefore, the present disclosure will be defined by the scope of the appended claims. Like reference numerals throughout the specification denote like elements.

Hereinafter, a valve according to exemplary embodiments of the present disclosure will be described with reference to the accompanying drawings.

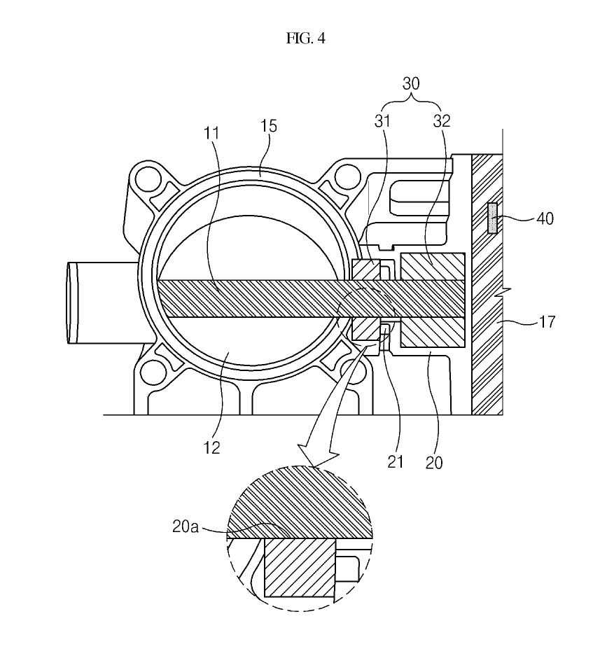

FIG. 3 is an exemplary perspective view of a valve according to an exemplary embodiment of the present disclosure. FIG. 4 is an exemplary view illustrating an arrangement of a sealing member 30 disposed within a valve according to the exemplary embodiment of the present disclosure. Referring to FIGS. 3 and 4, the valve may include a cylinder 15 in which a working fluid flows; a disk 12 rotatably disposed within the cylinder 15 and configured to control a flow path; a shaft 11 configured to transmit power to the disk 12; a gear box 17 connected to the shaft 11; and a connector 20 configured to connect the gear box 17 and the cylinder 15 to each other and may include a drain aperture 21 configured to discharge the working fluid leaked from the cylinder. The valve may be a butterfly valve and may include the shaft 11, wherein the shaft 11 may be mounted with the disk 12. In addition, a gear may be mounted at one side of the shaft 11.

The valve may be configured to adjust an angle of the shaft 11 to block the working fluid or adjust a flow rate/pressure. A pressure greater than atmospheric pressure may be formed near the cylinder 15 by a flow of the fluid. A sealing member 30 may be a seal suitable for a temperature/pressure of the working fluid. In other words, the sealing member 30 may prevent the working fluid from leaking under a normal condition.

When the working fluid flows in a direction toward the gear box 17 when the shaft 11 drives and the sealing member 30 leaks, the working fluid may be discharged to the exterior via the drain aperture 21. In other words, although the sealing member 30 leaks, the working fluid may be discharged to the exterior via the drain aperture 21 and damage may be prevented. Accordingly, malfunctions of the valve may be prevented by preventing the working fluid from leaking into the gear box 17.

A hollow aperture 20a into which the shaft 11 is rotatably inserted may formed on the connector 20, and the drain aperture 21 may connect to the hollow aperture 20a. When the working fluid leaks from the sealing members 30, the leaked working fluid may flow to the exterior via the drain aperture 21, which may prevent the leaked working fluid from leaking into the gear box 17. In particular, a plurality of drain apertures 21 may one or more, and the drain aperture 21 may be a size able to decrease a pressure near the cylinder 15 to an atmospheric pressure (e.g., exterior pressure). The valve may further include the sealing member 30 disposed within the connector 20 and configured to maintain the sealing between the shaft 11 and the hollow aperture 20a. Further, the working fluid may be prevented from leaking into the gear box 17 using the sealing member 30 between the disk 12 and the gear.

The sealing members 30 may be a plurality of sealing members, and the drain aperture 21 may be formed between the plurality of sealing members 30 in the connector 20. The sealing member 30 may include a first sealing member 31 and a second sealing member 32. When the first sealing member 31 fails (e.g., leaks), a pressure of a space between the first and second sealing members 31 and 32 may be about atmospheric pressure. In addition, the second sealing member 32 may prevent the working fluid from leaking into the gear box 17. The valve may further include a controller 40 disposed within the gear box 17 and configured to operate the gear box 17. Further, the controller 40 may be configured to adjust rotational angles of the disk 12 and the shaft 11.

The cylinder 15 may be disposed in an air supply system of a fuel cell and the working fluid may be air. The air supply system of the fuel cell may be divided into a front end and a rear end based on a stack and a valve may be mounted at each position. An environment of the valve mounted as described above may be different based on the position. In other words, dried air may flow at the front end, and increased temperature and increased humidity air may flow at the rear end. The present disclosure relates to a structure for sealing the valve mounted at the rear end based on the stack. The cylinder 15 may be disposed at the rear end of the stack of the fuel cell. Since the drain aperture 21 may be formed on the valve, the gear box 17 may be protected even when increased temperature and increased humidity working fluid flows.

The valve may include a cylinder 15 in which a working fluid flows; a disk 12 rotatably disposed within the cylinder 15 and configured to control a flow path; a shaft 11 configured to transmit power to the disk 12; a gear box 17 connected to the shaft 11 and configured to control a rotational angle of the shaft 11; a first sealing member 31 that encloses the shaft 11 and disposed between the disk 12 and the gear box 17; a second sealing member 32 disposed between the first sealing member 31 and the gear box 17; and a connector 20 that accommodates the first and second sealing members 31 and 32 and the cylinder 15 and may include a drain aperture 21 connected to the exterior between the first and second sealing members 31 and 32.

Even though specifications of the sealing member 30 may be set greater than conditions of the working fluid, sealing performance of the sealing member 30 may decrease under certain conditions (e.g., when the shaft 11 operates, or the like). When the sealing performance decreases as described above, the working fluid of the valve may leak into the gear box 17 and cause various problems. However, the gear box 17 may be protected from the working fluid by the drain aperture 21 between the first and second sealing members 31 and 32. Accordingly, side effects (e.g., freezing of the gear box 17 during winter, a short-circuit of the controller 40 within the gear box 17, and the like) may be prevented.

As described above, according to the exemplary embodiment of the present disclosure, the following advantages may be provided. First, the gear box may be protected from the working fluid leaked from the valve. Second, safety of the air supply system for a fuel cell system may increase. The effects of the present disclosure are not limited to the above-mentioned effects, and other effects that are not mentioned will be clearly understood by those skilled in the art through the accompanying claims.

Although the exemplary embodiments of the present disclosure have been disclosed for illustrative purposes, the present disclosure is not limited to the exemplary embodiments, and those skilled in the art will appreciate that various modifications, additions and substitutions are possible, without departing from the scope and spirit of the disclosure as disclosed in the accompanying claims. Accordingly, such modifications, additions and substitutions should also be understood to fall within the scope of the present disclosure.

What is claimed is:

1. A valve comprising:
a cylinder in which a working fluid flows;
a disk rotatably disposed within the cylinder and configured to control a flow path;
a shaft configured to transmit power to the disk;
a gear box connected to the shaft; and
a connector configured to connect the gear box and the cylinder and includes a drain aperture through which the working fluid leaked from the cylinder is discharged.

2. The valve according to claim 1, wherein a hollow aperture into which the shaft is rotatably inserted is formed on the connector and the drain aperture connects to the hollow aperture.

3. The valve according to claim 2, further comprising:
a sealing member disposed within the connector and configured to maintain the seal between the shaft and the hollow aperture.

4. The valve according to claim 3, wherein the sealing member is a plurality of sealing members and the drain aperture is formed between the plurality of sealing members within the connector.

5. The valve according to claim 1, further comprising:
a controller disposed within the gear box and configured to operate the gear box.

6. The valve according to claim 1, wherein the cylinder is disposed within an air supply system of a fuel cell and the working fluid is air.

7. The valve according to claim 6, wherein the cylinder is disposed at a rear end of a stack of the fuel cell wherein dried air flows at a front end of the stack of the fuel cell and increased temperature and increased humidity air flows at the rear end.

8. A valve comprising:
a cylinder in which a working fluid flows;
a disk rotatably disposed within the cylinder and configured to control a flow path;
a shaft configured to transmit power to the disk;
a gear box connected to the shaft and configured to adjust a rotational angle of the shaft;
a first sealing member that encloses the shaft and disposed between the disk and the gear box;
a second sealing member disposed between the first sealing member and the gear box; and
a connector configured to accommodate the first and second sealing members and the cylinder and includes a drain aperture connected to the exterior between the first and second sealing members.

9. A vehicle having a fuel cell system comprising the valve of claim 1.

10. A vehicle having a fuel cell system comprising the valve of claim 8.
